(19) United States
(12) Patent Application Publication
(10) Pub. No.: US 2018/0160673 A1
(43) Pub. Date: Jun. 14, 2018

(54) WEED-CONTROL DEVICE

(71) Applicant: Robert Bosch GmbH, Stuttgart (DE)

(72) Inventors: Amos Albert, Leonberg (DE); Andreas Michaels, Renningen (DE); Christian Glunk, Renningen (DE); Simon Boeck, Stuttgart (DE)

(21) Appl. No.: 15/576,047

(22) PCT Filed: May 19, 2016
(86) PCT No.: PCT/EP2016/061184

§ 371 Date: Nov. 21, 2017

(30) Foreign Application Priority Data
May 29, 2015 (DE) 102015209891.5

(51) Int. Cl. A01M 21/02; A01M 7/00; B05B 11/00; F16K 31/00

(52) U.S. Cl. CPC A01M 21/02; F16K 31/004; B05B 11/3038; A01M 7/0032

(57) ABSTRACT

A device for damaging weeds, the device having a pressure-conveyance unit, which is designed to convey a fluid under pressure, and a fluid-dispensing unit, which is fluidically connected to the pressure-conveyance unit and is furthermore developed to dispense the pressurized fluid to the weed in order to damage the weed, the fluid-dispensing unit including at least one valve that has a piezo-actuator or an electroactive polymer actuator or a magnetoresistive actuator.

### FIELD

The present invention relates to a device, a system and a method for damaging weeds.

### BACKGROUND INFORMATION

Weed control in the agricultural sector is a very labor-intensive task, especially in an organic cultivation that prohibits or restricts the use of chemicals.

German Patent No. DE 4039797 A1 describes a device for weed control in which weed is damaged with the aid of a flame actuator.

### SUMMARY

The present invention relates to a device, a system, and a method for damaging weed. The example device according to the present invention and the example method according to the present invention may make it possible to carry out an extremely fast, precise, and thus efficient, weed control. The device is characterized by a very simple and robust design. This is achieved in particular in that the fluid-dispensing unit according to the present invention has a valve that includes a piezo-actuator or an electroactive polymer actuator or a magnetoresistive actuator, i.e., an actuator that is able to be operated very rapidly and precisely, whereby the dispensing of the fluid to the weed is able to be controlled in a very simple and very precise manner. In other words, through a selective opening and closing of the actuator, the mass flow and the action time of the dispensed fluid are able to be precisely adjusted. The action times or opening/closing times of the valves preferably lie in a range that is greater than or equal to 0.1 to less than or equal to 0.2 ms. It is also possible that the valve has valve-opening/closing times that are adjustable in a defined manner or that the valve is actuable in a corresponding manner so that the valve-opening/closing times are able to be adjusted. Accordingly, for example, pulsing is possible during which the quantity of the dispensed fluid per “shot” is able to be precisely adjusted and effectively applied at the desired position with the goal of avoiding a waste of fluid. As a result, damage to the weed is able to be accomplished using a very small fluid quantity and a low energy requirement, which contributes to an environmentally friendly weed control.

Since the fluid-dispensing unit is furthermore connected to a pressure unit, the fluid may be dispensed in the form of pulses under high pressure, i.e., at a high exit velocity. The damage to the weed may thus be accomplished either mechanically, due to the kinetic energy of the fluid (“water-jet cutting”) dispensed in the form of pulses, or else chemically, due to the chemical properties of the fluid. As a result of this measure, there is hardly any earth movement during the weed-control process when the fluid strikes the weed because of the rapid pulse-type dispensing of the fluid, which is why the likelihood that additional weeds will sprout is considerably reduced.

The system according to the present invention makes it possible to carry out an area-wide weed control extremely rapidly and precisely; the system may be under the control of a person or be designed to operate autonomously. Since the dispensing of the fluid takes place in a selective manner and preferably in the form of pulses, it is advantageously possible (for the most part) to dispense with a compensation of the ego-movement of the moved system in the driving direction, which considerably reduces the complexity of the overall system or else allows for an increase in the driving speed.

It is advantageous if the pressure-conveyance unit is designed to conduct the fluid to the fluid-dispensing unit under such a high pressure that the weed is able to be damaged due to the kinetic energy of the fluid dispensed in a pulsed manner by the fluid-dispensing unit. In this context, the pressure preferably lies in a range that is greater than or equal to 500 bar; furthermore, it preferably lies in a range that is greater than or equal to 500 bar and less than or equal to 4000 bar. When dispensed, the fluid may preferably have an exit velocity of greater than or equal to 60 m/s and/or a kinetic energy that is greater than or equal to 0.03 J. In other words, the fluid or the bundled fluid jet, which may be developed as a water jet, for example, has such a high kinetic energy that, when dispensed, the weed onto which the fluid or the bundled fluid jet is applied is subjected to a corresponding mechanical destructive effect. Because of this design, a weed control is able to be carried out in a very simple and environmentally harmless way, and chemicals may be completely dispensed with.

It is furthermore advantageous if the pressure-conveyance unit has a pressure accumulator, which is designed to hold a pressurized fluid and to supply it to the fluid-dispensing unit. Because of this measure, it is now possible to keep the fluid to be dispensed permanently under high pressure regardless of the duration, the pulse frequency or the pulse sequence of the fluid dispensing process, and to make it available to the fluid-dispensing unit.

In addition, it is advantageous if the pressure-conveyance unit has a pump which is designed to pressurize the fluid to be dispensed and which is furthermore fluidically connected to the pressure accumulator and/or the fluid-dispensing unit. The pump is able to continually generate pressure in the pressure-conveyance unit or in the pressure accumulator and in the corresponding lines, so that the fluid to be dispensed is able to be continually conveyed under an even pressure to the fluid-dispensing unit and be applied to the weeds in a corresponding manner. Moreover, this development allows for very high pressures and thus also for very high mass applications of the fluid.

It is also advantageous if a chamber is provided, which is designed to hold the fluid to be dispensed and which is furthermore fluidically connected to the pump. The chamber is preferably disposed so as to be exchangeable. Due to this measure, an independent device is provided, which is able to transport and pressurize the fluid to be dispensed. The chamber may then again be replenished with the fluid or else be exchanged for a new replenished chamber. In other words, the weed-control device according to the present invention may be developed in the form of a “common rail system”, which is able to dispense a fluid under high pressure in a very precise manner and thereby allows for an efficient and environmentally friendly weed control.

In addition, it is advantageous if the fluid-dispensing unit has a nozzle, in particular a nozzle with a variable nozzle orifice. On the one hand, such a design makes it possible to generate a heavily bundled or focused fluid jet, which has high kinetic energy and consequently a pronounced damaging effect or a pronounced destructive effect. On the other hand, however, it is also possible to achieve different outflow characteristics as well as different sizes of the processed area by varying the nozzle orifice, i.e. the shape or the pass-through cross-section of the nozzle orifice. As a result, the fluid may include means for growth inhibition, for example, or means for destruction, so that a selective micro-injection of these means into the weed and also surface spraying of multiple weeds are able to be achieved by these means as a function of the development of the nozzle orifice. The damaging effect on the weed is therefore able to be achieved by the kinetic energy of the dispensed fluid, for one, or else also by the chemical properties of the fluid, which may be realized as a weed-elimination means, for another.

It is furthermore advantageous if the fluid-dispensing unit has a multitude of valves which have a piezo-actuator and/or an electroactive polymer actuator and/or a magnetoresistive actuator. It is especially advantageous if the multitude of valves including the piezo-actuator and/or the electroactive polymer actuator and/or the magnetoresistive actuator is actuable independently of each other. A very large area is able to be treated very precisely due to this measure. Furthermore, multiple valves may be connected in parallel to only a single pressure accumulator, so that fluid under pressure is able to be made available or dispensed at all valves using a simple means.

Also advantageous is a system having a device according to the present invention as described above. This device additionally includes a detection unit, which is designed to detect the weed, and it also includes a control unit which is designed to actuate the device as a function of data ascertained by the detection unit in such a way that when the device is operated, fluid is dispensed to the weed in order to damage it. Accordingly, in such a system, the device or the nozzle is able to be exactly positioned with the aid of an image-based control, so that a (fully) autonomous weed control is able to take place extremely rapidly and precisely. Among other things, this is achieved in that—in a departure from conventional methods—it is not the crop plant but rather the actual weed to be controlled that is specifically detected and selectively damaged; in other words, the weed-control device, i.e., the nozzle, is positioned directly against the weed in an automated manner. Especially in the case of crops that have small planting clearances (such as carrots), the present invention makes it possible to damage or destroy the undesired weed in direct proximity to the crop at a very early stage.

### BRIEF DESCRIPTION OF THE DRAWINGS

Below, the present invention is described in greater detail and by way of example on the basis of the figures.

FIG. 1 shows a schematized illustration of a weed-control device according to the present invention.

FIG. 2 shows a schematized illustration of one further development of the weed-control device according to the present invention with a multitude of valves.

FIG. 3 shows a schematized illustration of a system according to the present invention which includes the weed-control device of the present invention according to FIG. 1.

### DETAILED DESCRIPTION OF EXAMPLE EMBODIMENTS

In the description below of preferred exemplary embodiments of the present invention, identical or similar reference numerals are used for the elements shown in the various figures that act in a similar manner, and a repeated description of the elements is omitted.

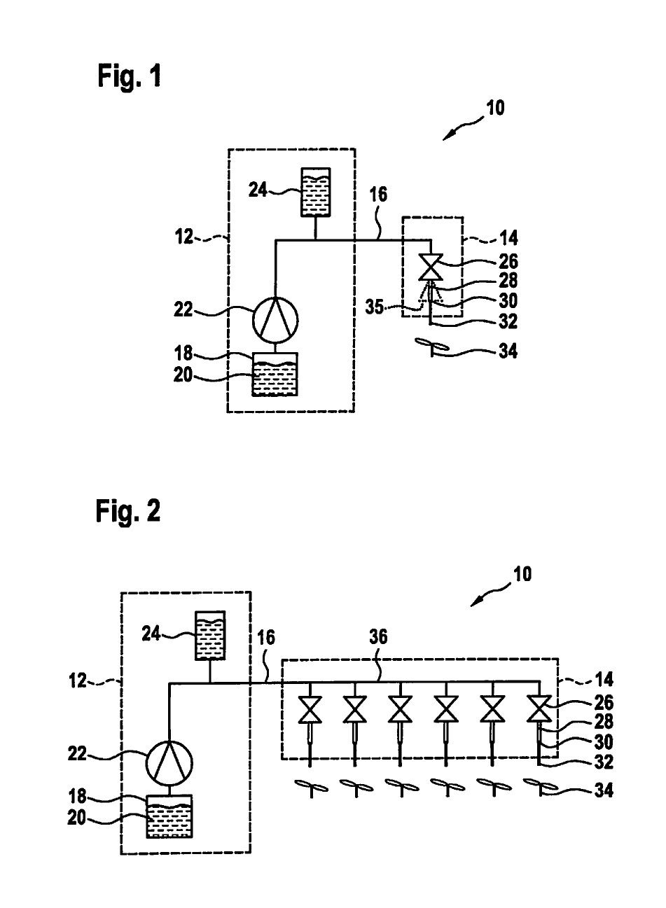

FIG. 1 shows a device for damaging weeds according to the present invention, which is denoted by reference numeral 10 as a whole.

Weed-control device 10 has a pressure-conveyance unit 12 and a fluid-dispensing unit 14. Pressure-conveyance unit 12 and fluid-dispensing unit 14 are fluidically connected to each other by way of a pressure line 16.

Pressure-conveyance unit 12 has a chamber 18 in which a fluid 20 to be dispensed is stored. Pressure-conveyance unit 12 furthermore has a pump 22, which is fluidically connected to chamber 18 via a line. In addition, pressure-conveyance unit 12 has a pressure accumulator 24. Pressure accumulator 24 is also fluidically connected via pressure line 16 to pump 22. Pump 22 is developed to pressurize fluid 20 situated inside chamber 18 and to make it available in pressure line 16 and to output it to pressure accumulator 24. Pressure accumulator 24 is in turn developed to permanently and uniformly convey pressurized fluid 20 via pressure line 16 to fluid-dispensing unit 14. Accordingly, fluid 20 is able to be pressurized, stored and made available to fluid-dispensing unit 14 with the aid of pressure-conveyance unit 12. Fluid 20 is water in this instance, but depending on the application, it may also be or include a herbicide.

Fluid-dispensing unit 14 has a valve 26. According to the present invention, valve 26 has a piezo-actuator in this instance. As an alternative, valve 26 may also have an electroactive polymer actuator and/or a magnetoresistive actuator. In addition, fluid-dispensing unit 14 includes a nozzle 28 which has a variable nozzle opening 30. By operating valve 26 with the aid of the piezo-actuator, a specific quantity of pressurized fluid 20 is therefore able to be dispensed in a selective and precise manner in order to thereby produce, for example, a focused and/or bundled fluid jet 32 that has kinetic energy for damaging a weed 34 (“water-jet cutting”). Through the selective opening and closing of valve 26, the mass flow and the active time are able to be adjusted and the fluid dispensing be thereby controlled very precisely. In addition, pulsing is an option, as a result of which the fluid use is able to be considerably reduced due to the selective, preferably brief, fluid dispensing.

Since nozzle 28 has a variable nozzle orifice 30, i.e., nozzle orifice 30 has a variable design, different outflow characteristics 35 as well as sizes of the area under work are able to be achieved. As indicated by the dashed line in FIG. 1, it is thus possible to produce a conical fluid jet 32, which is able to be sprayed across the surface of weed 34. The damaging effect in this instance is not the kinetic energy of outflowing fluid 20 or fluid jet 32 but the (chemical) property of fluid 20 as such. Therefore, fluid 20 may be developed as a herbicide, for instance. However, even in a development of this type, there is the considerable advantage that only a defined quantity of the fluid is dispensed, which is effectively administered in the desired position or across the desired working area, so that an unnecessary fluid use is avoided.

FIG. 2 shows another specific embodiment of weed-control device 10, which has a multitude of valves 26. Each valve 26 has a piezo actuator for this purpose. However, without departing from the scope of the present invention, valves 26 may also have different actuators from the group made up of a piezo-actuator, an electroactive polymer actuator and a magneto-resistive actuator. Via a shared pressure line 36, valves 26 are connected in parallel to pressure-conveyance unit 12. In this development as well, instead of utilizing the kinetic energy of fluid 20 for damaging weed 34, it is also possible to adjust nozzles 28 having the variable nozzle orifices in such a way that a conical fluid jet will be emitted.

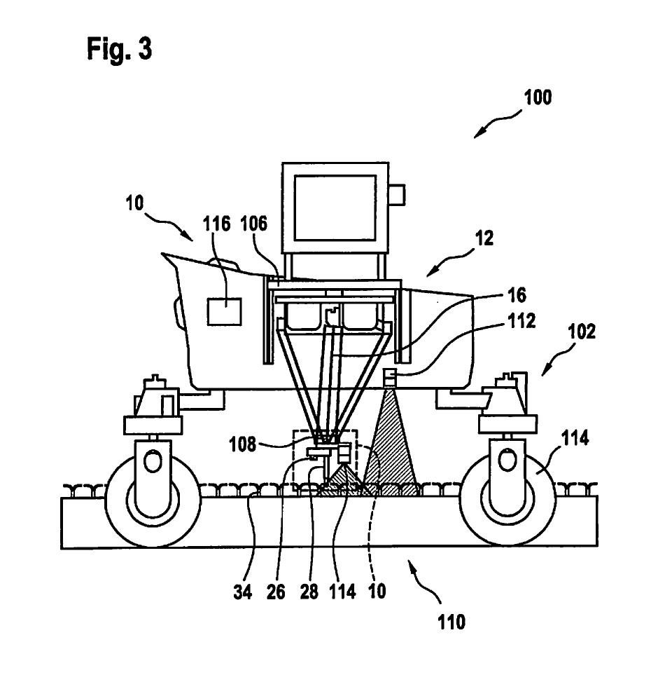

FIG. 3 shows a system for damaging weeds 34 according to the present invention, which has been provided with reference numeral 100 as a whole.

System 100 has a weed-control device 10 according to the present invention or a device 10 for damaging weeds 34 according to the afore-described specific embodiment from FIG. 1. However, any other specific embodiment of weed-control device 10 on system 100 according to the present invention is possible as well.

System 100 is developed as a mobile platform. For this purpose, system 100 has a drive unit 102 including wheels 104. However, any other conventional type of drive that is able to provide system 100 with mobility is possible as well.

System 100 furthermore has a manipulator unit 106 on whose lower manipulator section 108 device 10 is situated. As described previously, device 10 according to the present invention includes fluid-dispensing unit 14 provided with nozzle 28. Nozzle 28 is situated between manipulator unit 106 and the ground and points in the direction of weed 34. In order to allow for an image-based control for the exact positioning of device 10 or nozzle 28, system 100 furthermore has a detection unit 110 and a control unit 116. Detection unit 110 includes a classification unit 112 and a localization unit 114.

Classification unit 112 is developed as an imaging system in the form of a camera unit 112. Localization unit 114 is implemented as a visual-servoing camera 114 and situated in lower manipulator section 108 of manipulator unit 106 next to nozzle 28. Accordingly, visual-servoing camera 114 is disposed in a “suspended” manner above the ground and is correspondingly moved or positioned jointly with nozzle 28. Because of this setup, localization unit 114 or visual-servoing camera 114 is able to ascertain, in the immediate vicinity of weed 34, the relative positions of nozzle 28 with regard to weed 18 in an extremely precise manner. Localization unit 114 ascertains the relative position preferably with the aid of a computer unit (not shown), on the basis of the positional data or the detection data of classification unit 114.

However, without departing from the scope of the present invention, it is also quite possible that classification unit 112 and localization unit 114 are developed as one unit. Accordingly, unit 112, 114, including classification unit 112 and localization unit 114, would assume a dual task, i.e. the previously described classification task (detection of weed 34) and the ascertainment of the relative positions of nozzle 28 relative to weed 34 (visual servoing), which is used for guiding nozzle 28.

Control unit 116 receives the ascertained data of detection unit 110 or localization unit 114 and controls manipulator unit 106 and weed-control device 10 accordingly in such a way that nozzle 28 is brought into a corresponding position and fluid 20 is dispensed to weed 34 at a specific instant or when a certain position has been reached for a desired period of time, in order to damage the weed.

1-13. (canceled)

14. A device for damaging weed, comprising:
a pressure-conveyance unit designed to convey a fluid under pressure;
a fluid-dispensing unit which is fluidically connected to the pressure-conveyance unit and is developed to dispense the pressurized fluid to the weed in order to damage it, the fluid-dispensing unit having at least one valve that includes one of: (i) a piezo-actuator, (ii) an electroactive polymer actuator, or (iii) a magnetoresistive actuator.

15. The device as recited in claim 14, wherein the pressure-conveyance unit is developed to convey the fluid to the fluid-dispensing unit under such a high pressure that the weed is damaged due to kinetic energy of the fluid dispensed by the fluid-dispensing unit.

16. The device as recited in claim 15, wherein the fluid has an exit velocity that is greater than or equal to 60 m/s when dispensed by the fluid-dispensing unit, and a kinetic energy that is greater than or equal to 0.03 J.

17. The device as recited in claim 14, wherein the pressure-conveyance unit has a pressure accumulator, which is designed to hold a fluid under pressure and to output the fluid to the fluid-dispensing unit.

18. The device as recited in claim 17, wherein the pressure-conveyance unit has a pump which is designed to pressurize the fluid to be dispensed and which is fluidically connected to at least one of the pressure accumulator and the fluid-dispensing unit.

19. The device as recited in claim 18, wherein a chamber is provided, which is designed to hold the fluid to be dispensed and which is furthermore fluidically connected to the pump.

20. The device as recited in claim 14, wherein the fluid-dispensing unit has a nozzle having a variable nozzle orifice.

21. The device as recited in claim 14, wherein the fluid-dispensing unit has a multitude of valves that have at least one of a piezo-actuator, an electroactive polymer actuator, and a magnetoresistive actuator.

22. The device as recited in claim 21, wherein each of the multitude of valves is able to be actuated independently of one another.

23. A system for damaging weeds, comprising:
a device for damaging weed, the device including a pressure-conveyance unit designed to convey a fluid under pressure, and a fluid-dispensing unit which is fluidically connected to the pressure-conveyance unit and is developed to dispense the pressurized fluid to the weed in order to damage it, the fluid-dispensing unit having at least one valve that includes one of: (i) a piezo-actuator, (ii) an electroactive polymer actuator, or (iii) a magnetoresistive actuator.

24. The system as recited in claim 23, further comprising:
a detection unit designed to detect the weed; and
a control unit which is developed to actuate the device as a function of data ascertained by the detection unit in such a way that when the device is operated, the fluid is dispensed to the weed in order to damage it.

25. A method for damaging weeds, the method comprising:
providing a pressure-conveyance unit which is designed to convey a fluid under pressure; and
dispensing the pressurized fluid to the weed with the aid of a fluid-dispensing unit having a valve that includes one of a piezo-actuator, an electroactive polymer actuator, or a magnetoresistive actuator.

26. A method for damaging weeks, comprising:
dispensing a pressurized fluid at a weed to damage the weed, kinetic energy of the fluid damaging the weed.
